(19) United States
(12) Patent Application Publication
(10) Pub. No.: US 2003/0223923 A1
(43) Pub. Date: Dec. 4, 2003

(54) Apparatus for production of cellulose acetate

(76) Inventors: Phil P. Aspinwall, Odum, GA (US); Melinda K. Chancey, Screven, GA (US); Daren B. Pietsch, St. Simons Island, GA (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/160,897

(22) Filed: Jun. 3, 2002

(51) Int. Cl. B01J 8/00; B01J 10/00

(52) U.S. Cl. 422/188; 422/187

(57) ABSTRACT

A portable reaction system for acetylating cellulose to cellulose acetate comprising a skid-mounted acetylator, hydrolysis cell and hoist system is disclosed. The acetylator is pivotably mounted on the skid and is constructed so that its content can be transferred when the acetylator is pivoted. The hydrolysis cell is removably mounted on the skid and is adapted so that it can be lifted with the hoist system and moved to a position adjacent to acetylator to receive the contents of the acetylator when the acetylator is pivoted.

### FIELD OF THE INVENTION

The invention relates to a reaction apparatus for acetylation of a cellulose to cellulose acetate. In particular, the invention relates to a portable reaction system for acetylating cellulose, which is compact and easy to use and transport.

### BACKGROUND INFORMATION

Cellulose acetate is an organic acid ester of cellulose and is used for various purposes such as in fibers for clothes, cigarette filters, chip plastics, films and paints.

Typical of the processes for producing cellulose acetate is the so-called acetic acid process wherein acetic anhydride is used as an acetylating agent, acetic acid is used as a diluent and sulfuric acid is used as a catalyst. The process comprises (1) a pretreatment and activation step wherein a cellulose material having a relatively high α-cellulose content is disaggregated and disintegrated, and acetic acid, which may contain a small amount of an acid catalyst, is applied thereon and/or mixed therewith, (2) an acetylation step wherein the activated cellulose obtained in step (1) is treated with an acid mixture comprising acetic anhydride, acetic acid and an acid catalyst (such as sulfuric acid) to obtain a primary cellulose acetate, (3) an aging step wherein the primary cellulose acetate is hydrolyzed to obtain a secondary cellulose acetate having a desired degree of acetylation, and (4) an aftertreatment step wherein the secondary cellulose acetate thus obtained is separated from the reaction solution by precipitation, purified, stabilized and dried.

The acetylation step in a typical industrial cellulose acetate process is highly exothermic producing a large quantity of heat. This requires the cooling of liquid reagents prior to acetylation and of the acetylation reactor to regulate the reaction. Accordingly, typical industrial cellulose acetate processes require a large quantity of refrigeration to regulate the reaction temperature during the acetylation step.

Known cellulose acetate production process are described in several U.S. patents. For example, U.S. Pat. No. 3,767,642 teaches a process for producing secondary cellulose acetate from low cost wood pulp with low α-cellulose content. According to this patent, the secondary cellulose acetate is produced from primary cellulose acetate by a high-temperature hydrolysis process at a hydrolysis temperature ranging from 125° C. to 170° C.

U.S. Pat. No. 4,439,605 also teaches a process to produce secondary cellulose acetate using high-temperature acetylation and hydrolysis steps. The primary cellulose acetate for this process is produced by acetylating cellulose at a temperature from 50° C. to 85° C. with a relatively low sulfuric acid catalyst concentration, ranging from 0.5 to 5.0 weight parts per 100 weight parts dry cellulose. The process fully neutralizes the acid catalyst before introducing steam into the reaction mixture to elevate the system's temperature to between 125° C. and 175° C. Maintaining this temperature for 30 minutes to 6 hours hydrolyzes the primary acetate to cellulose diacetate. Reportedly, this process may also be used to produce cellulose acetate from low-grade pulps.

Another approach to the synthesis of cellulose acetate has been reported in U.S. Pat. No. 5,451,672. This patent teaches a process for producing cellulose acetate from a hard, low-grade pulp sheet having a high sheet density without impairing the acetylation reactivity of the pulp, characterized in that a pulp sheet having a sheet density of at least 0.5 g/cc is used as the cellulose material and the pulp sheet is disintegrated while feeding less than 40 parts by weight, based on 100 parts of pulp sheet, of water into the disintegrating section of a disintegrator in the step of disintegrating the material.

Cellulose acetate production processes typically require four main components: a disintegrator to provide a finely divided activated cellulose; an acetylation reactor to convert activated cellulose to primary cellulose acetate, for example, triacetate; a hydrolysis reactor to hydrolyze the primary cellulose to a secondary cellulose acetate having a desired degree of acetylation; and a precipitator to separate secondary cellulose acetate thus obtained from the reaction solution by precipitation. Other accessories are also needed to, for example, control temperature of acetylation reaction.

A typical apparatus for producing cellulose acetate is illustrated in, for example U.S. Pat. No. 2,635,097. An improved apparatus for acetylating cellulose is disclosed in U.S. Pat. No. 5,928,613. Such apparatus require large plant space to install and are infeasible to move from one site to another. Thus, if heretofore a need arose for short term production of cellulose acetate, one had to either fabricate and install an entire set of apparatus, or secure a remote source of cellulose acetate and transport the cellulose acetate to the facility in which it will be used. A need thus exists for a cellulose acetate production system that is compact and can be easily transported and put into use.

### SUMMARY OF THE INVENTION

It is an object of the invention to provide a portable apparatus for the production of cellulose acetate.

Other objects and advantages of the invention will be apparent from the following description.

According to an exemplary embodiment of the present invention, a portable cellulose acetate production system is provided, which comprises the following skid mounted components:

(a) a roller cabinet for vapor-phase activation of cellulose;

(b) an acetylator for acetylation of activated cellulose to triacetate;

(c) a cold glycol bath for pre-cooling of reagents;

(d) a hydrolysis cell for hydrolysis of triacetate to diacetate;

(e) a precipitation tank for precipitation/washing of diacetate; and

(f) a hoist system for lifting and moving components of the system to enable the batchwise transfer of process fluids from one process stage to the net stage.

The further scope and applicability of the present invention will be apparent from the detailed description given hereinafter. However, it should be understood that the detailed description, while indicating preferred embodiments of the invention, is provided by way of illustration only, since various changes and modifications within the spirit and scope of the invention will be apparent to those skilled in the art.

### BRIEF DESCRIPTION OF THE DRAWINGS

So that the manner in which the above recited features, advantages and objects of the present invention are attained and can be understood in detail, more particular description of the invention summarized above may be had by reference to the embodiments thereof which are illustrated in the appended drawings.

FIG. 1 is a schematic side view of the portable cellulose acetate production system of the invention.

FIG. 2 is a schematic top view of the portable cellulose acetate production system of the invention.

FIG. 3 is a schematic front view of the portable cellulose acetate production system of the invention.

FIG. 4 is a schematic rear view of the portable cellulose acetate production system of the invention.

### DETAILED DESCRIPTION OF THE INVENTION

The present invention relates to a reaction apparatus for production of a secondary cellulose acetate. The apparatus of the invention is aimed at providing a self-contained, compact and portable system for producing secondary cellulose acetate to enable a system for the production of cellulose acetate to be quickly and easily provided where the need for such production arises. This is achieved by installing all of the essential components of such a system on a skid, which is sized for transport by conventional over-land means. In one embodiment of the invention, the assembled dimensions of the skid are approximately 10 feet long, 6 feet wide, and 11.5 feet tall. The hoist structure on the skid is removable for transportation. With the hoist structure removed, the height of the skid is reduced to approximately 7 feet.

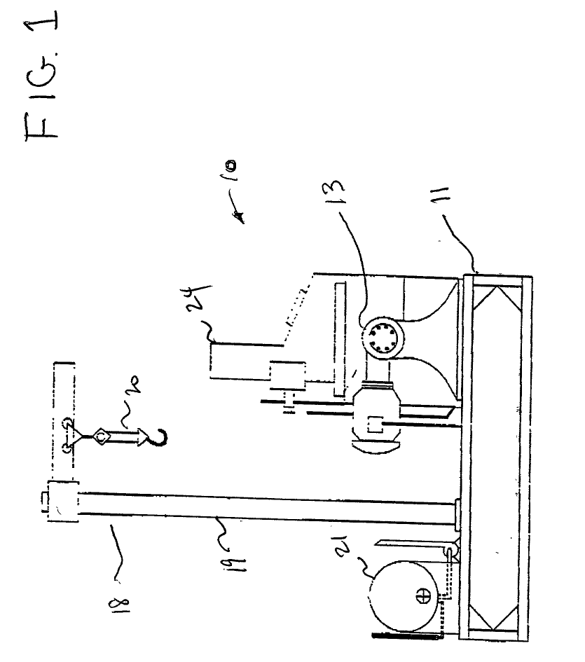

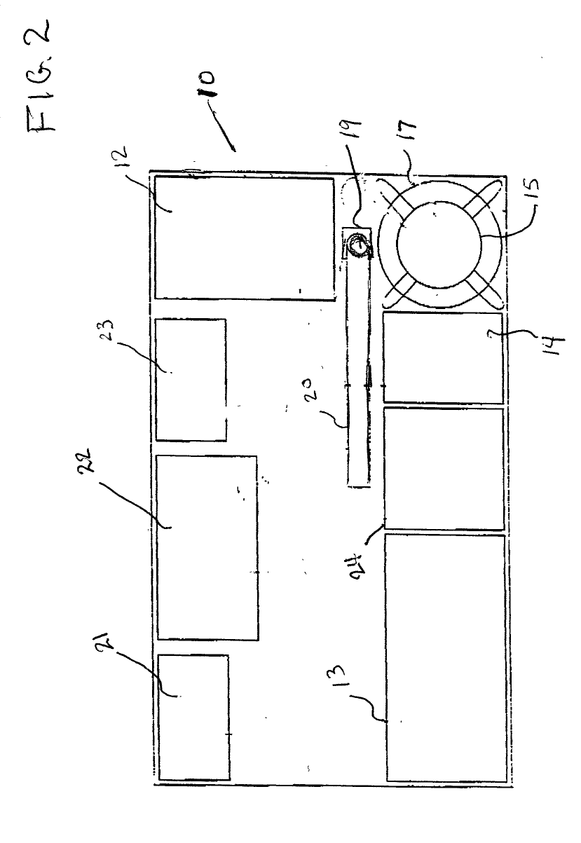

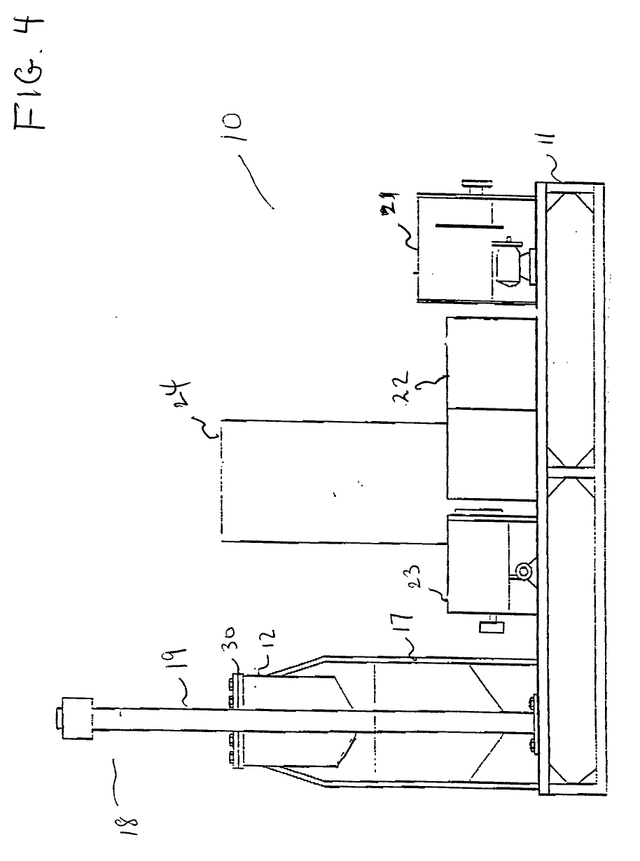

Embodiments of the present invention are described on the basis of the accompanying drawings. FIG. 1 through FIG. 4 are schematic diagrams showing side, top, front and rear views of an embodiment of the portable cellulose acetate production apparatus of the present invention.

The portable cellulose acetate production apparatus 10 comprises a skid 11 on which the following components of the apparatus 10 are mounted; roller cabinet 12 for the pretreatment of cellulose material, acetylator 13 for use in the acetylation of cellulose material to primary cellulose acetate, such as triacetate, chiller bath 14 for pre-cooling of reagents, hydrolysis cell 15 for hydrolysis of primary cellulose acetate to secondary cellulose acetate, precipitation tank 17 for precipitation and washing of secondary cellulose acetate flake, and hoist system 18 comprised of boom 19 and hoist 20. In a preferred embodiment of the invention, the apparatus further comprises acetylation heater system 21 and acetylation chiller 22 for temperature control of the acetylation reaction. In yet another preferred embodiment of the invention, the apparatus further comprises hydrolysis heater system 23 for temperature control of hydrolysis cell 15 and control system 24 to control the operating temperatures of acetylator 13, the timing of reaction stages and prompts for operator actions.

In a further preferred embodiment of the invention, all of the components of portable cellulose acetate production apparatus 10 are fixedly mounted on skid 11, with the exception of hydrolysis cell 15 and precipitation tank 17, which are releasably mounted on skid 11, so that in the operation of cellulose acetate production apparatus 10 they can be moved to effectuate the process steps required for cellulose acetate production. As previously indicated, hoist system 18 is removably mounted to facilitate the shipping of apparatus 10.

In conducting the process of the present invention, portable cellulose acetate production apparatus 10 is first transported to a desirable production site where water, electric, compressed air, drainage, ventilation and other utilities necessary to operate apparatus 10 are available. Electricity is needed for process control and motors, water supply for cleaning and process requirements, air supply for pneumatically lifting acetylator 13 and for pressurizing hydrolysis cell 15, ventilation for removal of vapors from roller cabinet 12, acetylator 13, and precipitation tank 17, and drainage for precipitation tank 17 and for run-off from equipment cleaning.

In operation, starting cellulose material preferably in the form of shredded/fluffed wood pulp is introduced to roller cabinet 12 for vapor-phase pretreatment with acetic acid. Roller cabinet 12 is motor driven to rotate at 2 to 8 RPM, and preferably 3 to 5 RMP. The pretreated pulp obtained from roller cabinet 12 is then manually moved to acetylator 13 where it is treated with glacial acetic acid, acetic anhydride and an acid catalyst while being stirred with a sigma-blade mixer. Acetylator 13 is fixedly mounted on skid 11 but is adapted so that it can be pneumatically tilted to be emptied and cleaned. Acetylator 13 is jacketed to enable the heating and cooling of acetylator 13 and its contents with a hot heat transfer fluid, which is preferably glycol at approximately 76° C., from acetylator heater system 21, and with cooling fluid, which is preferably glycol at approximately −20° C., from acetylator chiller 22. Acetylator 13 is heated to initiate the acetylation reaction and after the acetylation reaction commences is cooled to remove the heat of reaction.

After the acetylation reaction is completed boom 19 and hoist 20 of hoist system 18 are maneuvered to a position over hydrolysis cell 15, which is detachably mounted to skid 11. Hydrolysis cell 15 is provided with fittings for attachment of hoist 20. Hoist 20 is attached to hydrolysis cell 15 and it is moved to a position adjacent to acetylator 13. Cell top 24 of hydrolysis cell 15 opens for filling. Acetylator 13 is then open and tipped to deposit its contents of primary cellulose acetate into hydrolysis cell 15.

Hydrolysis cell 15 is jacketed to enable the heating of hydrolysis cell 15 and its contents with a heat transfer fluid, which is preferably water, from hydrolysis heater system 23.

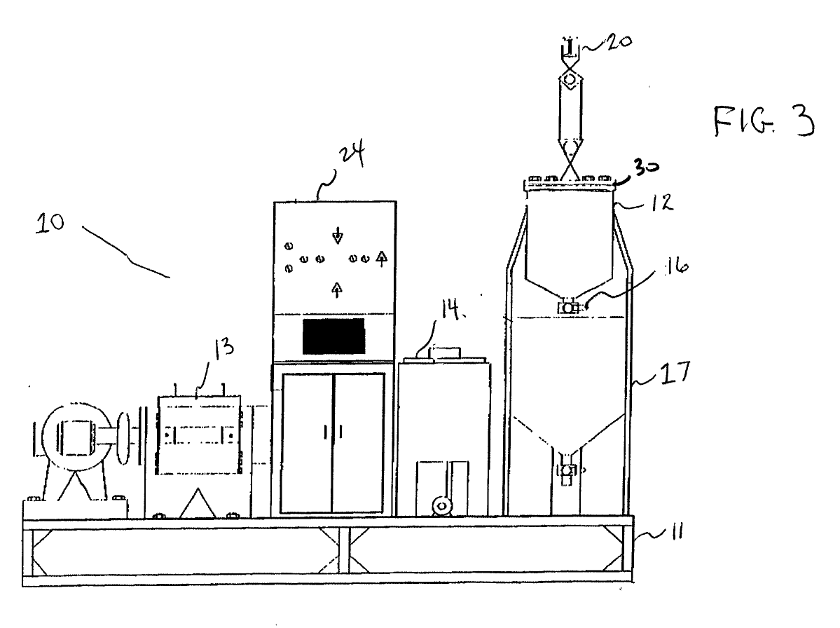

In hydrolysis cell 15, the primary cellulose acetate is hydrolyzed to form secondary cellulose acetate having the desired degree of acetylation. For example, cellulose triacetate is conventionally converted to cellulose diacetate. As shown in FIG. 3, hydrolysis cell 15 and precipitation tank 17 are sized so that hydrolysis cell 15 can be removably mounted on top of precipitation tank 17 to enable the contents of hydrolysis cell 15 to be drained into precipitation tank 17 through hydrolysis cell drain valve 16.

Hoist system 18 is used to lift and move hydrolysis cell 15 to a position on top of precipitation tank 17 after it is loaded with primary cellulose acetate. After the desired secondary cellulose acetate is obtained in hydrolysis cell 15, the secondary cellulose acetate reaction mixture is then transferred to precipitation tank 17 by pressurizing the hydrolysis cell with compressed air and then opening valve 16. A dilute aqueous acetic acid solution is added to precipitation tank 17 to form cellulose acetate precipitates, such as diacetate flake. The cellulose acetate precipitates are recovered in precipitation tank 17 by separating them from the reaction solution, and washed.

In a preferred embodiment of the invention, precipitation tank 17 is removably mounted on skid 11 and equipped with fitting so that it can be moved with hoist system 18 to a centrifuge, either on skid 11 or remote from it, for de-watering of the washed cellulose acetate precipitate.

The above description of the invention is intended to be illustrative and not limiting. Various changes or modifications in the embodiments described may occur to those skilled in the art. These can be made without departing from the spirit or scope of the invention.

What is claimed is:

1. A skid mounted portable cellulose acetate production system, comprising:
a skid;
an acetylator for acetylation of cellulose material to cellulose triacetate, said acetylator being mounted on said skid;
an hydrolysis cell for hydrolysis of cellulose triacetate to cellulose diacetate, said hydrolysis cell being removably mounted on said skid and being adapted so that it can be lifted and moved, and having a top which opens to enable the hydrolysis cell to receive cellulose triacetate from said acetylator;
a hoist system mounted on said skid and adapted so that it can lift the hydrolysis cell and move it to a position adjacent to said acetylator; and
said acetylator being pivotably mounted on said skid and adapted so that cellulose diacetate in the acetylator can be transferred into the hydrolysis cell when the hydrolysis cell is in a position adjacent to the acetylator by pivoting the acetylator on its mount to a position over the hydrolysis cell.

2. The skid mounted portable cellulose acetate production system according to claim 1, further comprising a precipitation tank mounted on said skid and sized and adapted so that the hydrolysis cell can be removably mounted on top of said precipitation tank; said hoist system being adapted to lift and move the hydrolysis cell to mount it on the top of the precipitation tank; said hydrolysis cell being adapted so that it can be lifted and mounted on top of said precipitation tank using said hoist system; and said hydrolysis cell having a bottom drain valve which is positioned to enable said hydrolysis cell to be drained into said precipitation tank when said valve is opened while the hydrolysis cell is over said precipitation tank.

3. The portable cellulose acetate production system of claim 2, further comprising:
(a) a temperature control system for controlling the temperature of the acetylator; and
(b) a temperature control system for controlling the temperature of the hydrolysis vessel.

4. The portable cellulose acetate production system of claim 1, wherein the hoist system is removably mounted on said skid.
